(19) United States
(12) Patent Application Publication
(10) Pub. No.: US 2026/0056335 A1
(43) Pub. Date: Feb. 26, 2026

(54) SENSOR MODULE

(71) Applicant: ANALOG DEVICES, INC., Wilmington, MA (US)

(72) Inventors: David Frank Bolognia, Charlestown, MA (US); Alessandro Visco Salvucci, Newton, MA (US)

(21) Appl. No.: 18/810,968

(22) Filed: Aug. 21, 2024

(51) Int. Cl. G01T 1/20

(52) U.S. Cl. CPC G01T 1/2019

(57) ABSTRACT

A sensor assembly for an imaging system is disclosed. The sensor assembly can include a sensor module having: a device package having a first vertical interconnect structure, a processor die electrically connected to the first vertical interconnect structure via conductive traces, a radiation shield mounted to the processor die, and an encapsulant in which the first vertical interconnect structure, the processor die, and the radiation shield are at least partially embedded within. The sensor assembly can also include a sensor die disposed over the device package and in electrical communication with the processor die. During operation of the sensor module, the first vertical interconnect structure can communicate signals from the sensor die to the processor die. The radiation shield can be positioned between the processor die and the sensor die. The sensor assembly can include a second vertical interconnect structure at least partially embedded in the encapsulant.

### BACKGROUND

### Field

This disclosure relates generally to a sensor module including a sensor and processing electronics.

### Description of the Related Art

Advancements have been made to improve the configurability and applicability of sensor modules. Such sensor modules may be used in imaging systems. As sensor modules have become more complex, modular solutions have been developed to address the challenges posed by demands for compact and efficient designs.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the implementations may be embodied or carried out in a manner that achieves or optimizes one advantage or group of advantages as taught herein without necessarily achieving other objects or advantages as may be taught or suggested herein.

All of these implementations are intended to be within the scope of the implementations herein disclosed. These and other implementations will become readily apparent to those skilled in the art from the following detailed description of the preferred implementations having reference to the attached figures, the implementations not being limited to any particular preferred implementations disclosed.

In some implementations, a sensor assembly for an imaging system can include: a sensor module, the sensor module including: a device package including: a first vertical interconnect structure; a processor die electrically connected to the first vertical interconnect structure via conductive traces; a radiation shield mounted to the processor die; and an encapsulant in which the first vertical interconnect structure, the processor die, and the radiation shield are at least partially embedded within; and a sensor die disposed over the device package and in electrical communication with the processor die, wherein during operation of the sensor module, the first vertical interconnect structure communicates signals from the sensor die to the processor die; wherein the radiation shield is positioned between the processor die and the sensor die.

In some implementations, the sensor assembly includes a second vertical interconnect structure, wherein the first vertical interconnect structure is positioned at a first end of the device package and the second vertical interconnect structure is positioned at a second end of the device package, and wherein the second vertical interconnect structure is at least partially embedded in the encapsulant. In some implementations, the radiation shield is mounted to the processor die by an adhesive. In some implementations, the device package further includes at least one of active circuitry or passive circuitry. In some implementations, the first vertical interconnect structure and the processor die are mounted to a substrate and the conductive traces are embedded in or on the substrate.

In some implementations, the sensor assembly includes a redistribution layer disposed on a lower surface of the first vertical interconnect structure and the processor die, wherein the redistribution layer includes the conductive traces. In some implementations, the sensor assembly includes: a flexible substrate, wherein a plurality of sensor modules are mounted to the flexible substrate, and a stiffener, wherein the flexible substrate is attached to and folded around an edge of the stiffener. In some implementations, the flexible substrate includes a connector assembly. In some implementations, the sensor assembly includes an assembly substrate, wherein a plurality of sensor modules are mounted to the assembly substrate, and wherein the assembly substrate includes a connector assembly.

In some implementations, the first vertical interconnect structure includes a laminate substrate. In some implementations, the first vertical interconnect structure includes copper pillars encapsulated in a molding compound.

In some implementations, a sensor assembly for an imaging system can include: a sensor module, the sensor module including: a device package including: a first vertical interconnect structure; a processor die electrically connected to the first vertical interconnect structure via conductive traces; and an encapsulant in which the first vertical interconnect structure and the processor die are at least partially embedded in the encapsulant; and a sensor die disposed over the device package and in electrical communication with the processor die, wherein during operation of the sensor module, the first vertical interconnect structure communicates signals from the sensor die to the processor die.

In some implementations, the sensor assembly includes a radiation shield mounted to the processor die by an adhesive, the radiation shield is positioned between the processor die and the sensor die, wherein the radiation shield is at least partially embedded in the encapsulant. In some implementations, the sensor assembly includes a second vertical interconnect structure, wherein the first vertical interconnect structure is positioned at a first end of the device package and the second vertical interconnect structure is positioned at a second end of the device package, and wherein the second vertical interconnect structure is at least partially embedded in the encapsulant. In some implementations, the device package further includes at least one of active circuitry or passive circuitry. In some implementations, the first vertical interconnect structure and the processor die are mounted to a substrate and the conductive traces are embedded in or on the substrate.

In some implementations, the sensor assembly includes a redistribution layer disposed on a lower surface of the first vertical interconnect structure and the processor die, wherein the redistribution layer includes the conductive traces. In some implementations, the sensor assembly includes: a flexible substrate, wherein a plurality of sensor modules are mounted to the flexible substrate, and a stiffener, wherein the flexible substrate is attached to and folded around an edge of the stiffener. In some implementations, the flexible substrate includes a connector assembly. In some implementations, the sensor assembly an assembly substrate, wherein a plurality of sensor modules are mounted to the assembly substrate, and wherein the assembly substrate includes a connector assembly.

In some implementations, the first vertical interconnect structure includes a laminate substrate. In some implementations, the first vertical interconnect structure includes copper pillars encapsulated in a molding compound.

In some implementations, a method of manufacturing a sensor assembly for an imaging system can include: forming a sensor module, wherein forming the sensor module includes: forming a device package, wherein forming the device package includes: providing a first vertical interconnect structure; electrically connecting a processor die to the first vertical interconnect structure via conductive traces; mounting a radiation shield to the processor die; and at least partially embedding in an encapsulant the first vertical interconnect structure, the processor die, and the radiation shield; and mounting a sensor die to the device package.

In some implementations, the method includes providing a substrate, wherein the first vertical interconnect structure and the processor die are mounted to the substrate and the conductive traces are embedded in or on the substrate. In some implementations, the method includes forming a redistribution layer on a lower surface of the first vertical interconnect structure and the processor die, wherein the redistribution layer includes the conductive traces. In some implementations, the method includes providing a second vertical interconnect structure, wherein the first vertical interconnect structure is positioned at a first end of the device package and the second vertical interconnect structure is positioned at a second end of the device package, and wherein the second vertical interconnect structure is at least partially embedded in the encapsulant In some implementations, the method includes: mounting a plurality of sensor modules to a flexible substrate, and attaching the flexible substrate around a stiffener and folding the flexible substrate around an edge of the stiffener.

In some implementations, the method includes mounting a plurality of sensor modules to an assembly substrate, wherein the assembly substrate includes a connector assembly. In some implementations, the method includes grinding down the encapsulant expose conductive pads on an upper surface of the first vertical interconnect structure.

In some implementations, a sensor assembly for an imaging system can include: a plurality of sensor modules including; a device package including: a substrate including first surface and a second surface opposite the first surface, wherein electrical terminals disposed on the second surface; a first vertical interconnect structure including electrical terminals on a first surface, wherein a second surface opposite the first surface is disposed on a first end of the first surface of the substrate; a second vertical interconnect structure including electrical terminals on a first surface and a second surface opposite the first surface is disposed on a second end opposite the first end of the first surface of the substrate; a processor die including a first side and a second side opposite the first side, the second side of the processor die mounted to the substrate, wherein the first vertical interconnect structure is electrically connected to the processor die and configured for communicating analog signals to the processor die; a radiation shield mounted over the first side of the processor die by an adhesive; a plurality of passive devices disposed on the substrate; and an encapsulant, wherein the first vertical interconnect structure, the second vertical interconnect structure, the processor die, the radiation shield, and the plurality of passive devices are at least partially embedded in the encapsulant; and a sensor die including a first surface and a second surface opposite the first surface, wherein the second surface of the sensor die is mounted over the device package and in electrical communication with the processor die, and wherein the first vertical interconnect structure communicates signals from the sensor die to the processor die; a flexible substrate having a connector assembly, wherein the electrical terminals disposed on the second surface of the substrate of the plurality of sensor modules are mounted to the flexible substrate; and a stiffener, wherein the flexible substrate is folded around an edge of the stiffener.

In some implementations, the electrical terminals include ball grid arrays. In some implementations, the encapsulant of the device package is ground down to expose the electrical terminals on the first surface of the first vertical interconnect structure and the second vertical interconnect structure. In some implementations, the sensor assembly includes sensor assembly an underfill disposed between the device package and the sensor die. In some implementations, the radiation shield includes tungsten.

In some implementations, the radiation shield is completely embedded in the encapsulant. In some implementations, the processor die includes an analog-to-digital converter. In some implementations, the sensor die includes a photodiode array chip. In some implementations, the first surfaces of the sensor dies are co-planar.

In some implementations, the stiffener includes a material having a low or balanced coefficient of thermal expansion. In some implementations, the sensor assembly includes one or more passive devices disposes on the flexible substrate. In some implementations, the one or more passive devices include resistors. In some implementations, the first vertical interconnect structure and second vertical interconnect structure include conductive vias through a mold compound.

In some implementations, the conductive vias include through mold conductive vias. In some implementations, the sensor assembly includes conductive traces in the substrate to provide a connection between the first vertical interconnect structure and the processor die. In some implementations, the radiation shield is mounted to the processor die by an adhesive. In some implementations, the adhesive includes epoxy.

In some implementations, a method of manufacturing a sensor module for an imaging system can include: forming a plurality of sensor modules, wherein forming the plurality of sensor modules includes: forming a device package, wherein forming the device package includes: providing a substrate including a first surface and a second surface opposite the first surface, where electrical terminals are disposed on a second surface of the substrate; mounting a first vertical interconnect structure and a second vertical interconnect structure to the first surface of the substrate, electrical terminals disposed on a first surface of the first vertical interconnect structure and the second vertical interconnect structure, wherein a second surface opposite the first surface of the first vertical interconnect structure is mounted on a first end of the substrate and a second surface opposite the first surface the second vertical interconnect structure is mounted on a second end opposite the first end of the substrate; mounting a processor die including a first side and a second side opposite the first side, the second side of the processor die mounted to the substrate, wherein the first vertical interconnect structure is electrically connected to the first vertical interconnect structure and configured for communicating analog signals to the processor die; mounting a radiation shield over the first side of the processor die by an adhesive; mounting a plurality of passive devices on the first surface of the substrate; and at least partially embedding in an encapsulant the first vertical interconnect structure, the second vertical interconnect structure, the processor die, the radiation shield, and the plurality of passive devices; and mounting a sensor die including a first surface and a second surface opposite the first surface to the device package, the second surface of the sensor die mounted over the device package and in electrical communication with the processor die, wherein the first vertical interconnect structure communicates signals from the sensor die to the processor die; mounting the electrical terminals disposed on the second surface of the substrate of the plurality of sensor modules to a flexible substrate having a connector assembly; attaching the flexible substrate to a stiffener; and folding the flexible substrate around an edge of stiffener.

In some implementations, the method includes grinding down the encapsulant and the electrical terminals disposed of the first vertical interconnect structure and the second vertical interconnect structure to form conductive pads. In some implementations, the method includes mounting electrical terminals disposed on the second surface of the sensor die to the first vertical interconnect structure and the second vertical interconnect structure, wherein the electrical terminals of the sensor die is in mechanical and electrical communication with the electrical terminals disposed of the first vertical interconnect structure and the second vertical interconnect structure. In some implementations, the method includes mounting electrical terminals to the conductive pads, and mounting the sensor die to the electrical terminals. In some implementations, an adhesive attaches the flexible substrate to the stiffener. In some implementations, the adhesive includes an epoxy.

In some implementations, a sensor module for an imaging system can include: a device package including: a substrate; a first vertical interconnect structure and a second vertical interconnect structure disposed on a first surface of the substrate; a processor die mounted to the substrate, wherein conductive traces electrically connect the first vertical interconnect structure to the processor die; a radiation shield mounted over the processor die; a plurality of passive devices disposed on the substrate; an encapsulant in which the first vertical interconnect structure, the second vertical interconnect structure, the processor die, the radiation shield, and the plurality of passive devices are at least partially embedded; and a sensor die disposed over the device package and in electrical communication with the processor die, wherein during operation of the sensor module, the first vertical interconnect structure communicates signals from the sensor die to the processor die; a flexible substrate having a connector assembly, wherein a plurality of combined device packages and sensor dies are mounted to the flexible substrate; and a stiffener, wherein the flexible substrate is attached to and folded around an edge of the stiffener.

In some implementations, the first vertical interconnect structure is disposed on a first end of the substrate and the second vertical interconnect structure is disposed on a second end of the substrate. In some implementations, the encapsulant of the device package is ground down to expose electrical terminals disposed on a first surface of the first vertical interconnect structure and the second vertical interconnect structure. In some implementations, analog signals are communicated along the conductive traces from the first vertical interconnect structure and the processor die. In some implementations, the sensor module includes an underfill disposed between the device package and the sensor die.

In some implementations, the radiation shield includes tungsten. In some implementations, the radiation shield is completely embedded in the encapsulant. In some implementations, the processor die includes an analog-to-digital converter. In some implementations, the sensor die includes a photodiode array chip.

### BRIEF DESCRIPTION OF THE DRAWINGS

These and other features, aspects, and advantages of the disclosure are described with reference to drawings of certain implementations, which are intended to illustrate, but not to limit, the present disclosure. It is to be understood that the accompanying drawings, which are incorporated in and constitute a part of this specification, are for the purpose of illustrating concepts disclosed herein and may not be to scale. In the drawings, similar elements have similar reference numerals.

FIG. 1 illustrates a schematic perspective view of an example assembly for processing light into electrical signals, according to various implementations.

FIG. 2A illustrates a schematic side view of the example assembly of FIG. 1.

FIG. 2B illustrates a schematic top view of the example assembly of FIG. 1.

FIG. 2C illustrates a schematic top view of a flexible substrate, according to various implementations.

FIG. 3 illustrates a perspective view of an exemplary sensor module.

FIG. 4 illustrates a perspective view of a partially assembled exemplary sensor module, according to some implementations.

FIG. 5 illustrates a top perspective view of the partially assembled sensor module of FIG. 4.

FIG. 6 illustrates a side schematic view of the encapsulated device package of the sensor module of FIGS. 3-5.

FIG. 7 illustrates a side schematic view of a sensor die attached the encapsulated device package of the sensor module of FIGS. 3-6.

FIG. 8 illustrates an example process for assembling a sensor module, according to various implementations.

FIG. 9 illustrates an example process for assembling a sensor assembly, according to various implementations.

FIG. 10 illustrates a schematic side view of another exemplary of the device package having through-mold-vias.

FIG. 11A illustrates a schematic perspective top view of another exemplary assembly having a connector connected to a substrate, according to various implementations.

FIG. 11B illustrates a schematic perspective bottom view of the assembly of FIG. 11A.

### DETAILED DESCRIPTION

Although several implementations, examples, and illustrations are disclosed below, it will be understood by those of ordinary skill in the art that the implementations described herein extend beyond the specifically disclosed implementations, examples, and illustrations and includes other uses of the implementations and obvious modifications and equivalents thereof. Implementation are described with reference to the accompanying figures, wherein like numerals refer to like elements throughout. The terminology used in the description presented herein is not intended to be interpreted in any limited or restrictive manner simply because it is being used in conjunction with a detailed description of some specific implementations. In addition, implementations can comprise several novel features. No single feature is solely responsible for its desirable attributes or is essential to practicing the implementations herein described.

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of implementations.

Sensor modules that include both a sensor and a processor (e.g., a general purpose processor or an Application-Specific Integrated Circuit, or ASIC) can be useful in a variety of optical, electrical, and electronic applications. A consideration when designing sensor modules is ensuring that the sensor module (e.g., including the sensor and the processor) is compact and/or small enough to comply with the overall system design requirements, which can be important whether the modules are employed individually or are assembled in an array. For example, in some arrangements, an array of sensor modules is used to detect signals received in various locations or at different angles. In some applications, an array of sensor modules can be used for imaging applications, such as for x-ray detection in a computed tomography (CT) device. Arrays can include one-dimensional strings or two-dimensional (2D) arrays. CT devices can be used in a variety of applications, including medical imaging, industrial imaging, nondestructive testing, imaging subsurface minerals, and various other uses. Because the sensor modules are positioned adjacent one another in the array in some implementations, the sensor, the processor, and other components must fit within their associated area in the array. Moreover, because there are neighboring sensor modules on each side of a particular sensor module, features connecting the sensor module to the external control module should not interfere with neighboring sensor modules. In other imaging applications, sensor modules can be used to detect sound waves within an ultrasound system. In yet other implementations, sensor modules can be employed in nuclear imaging applications, such as in positron emission tomography (PET) scans and gamma ray imaging applications. In nuclear imaging applications, a sensor (or sensor array in some implementations) can be used to image an object (e.g., a patient) that has been provided with (e.g., ingested or been injected with) a radioactive tracer material.

The disclosed implementations utilize a multiple tile (e.g., four-way tileable) sensor module having chiplets comprised of a sensor die (e.g., a photodiode array chip) and an overmolded integrated device package having a processor die (e.g., an Application-Specific Integrated Circuit (ASIC), a radiation shield, and passive components. These chiplets can be tiled and connected with a flexible PCB connector that has component(s) and connector(s) reflowed (e.g., local reflow techniques) onto it. The sensor module can be kept thermally and mechanically stable through the use of a low and/or balanced coefficient of thermal expansion (CTE) metal or a ceramic stiffener, which is placed over the flex PCB connector and adhered to the bottom of the overmolded integrated device packages through the use of an adhesive. Additionally, a segment of the flex containing the connector can wrapped around the bottom of the stiffener and attached in place.

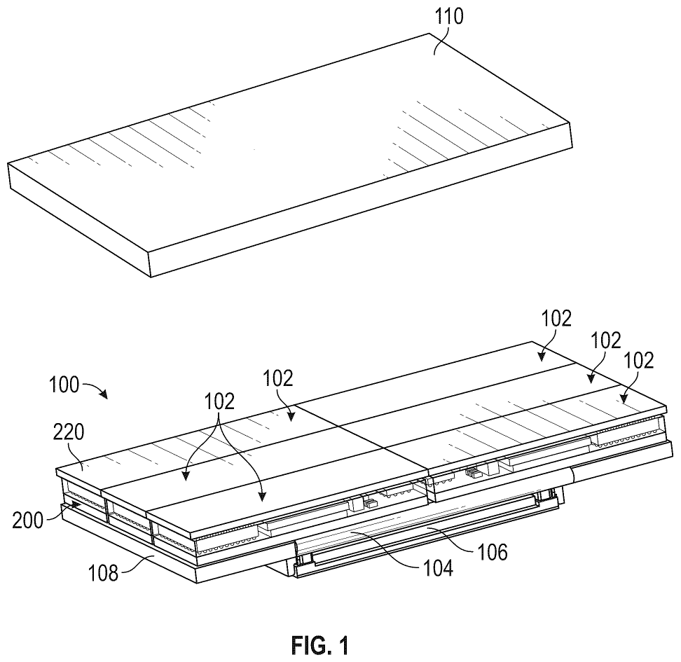

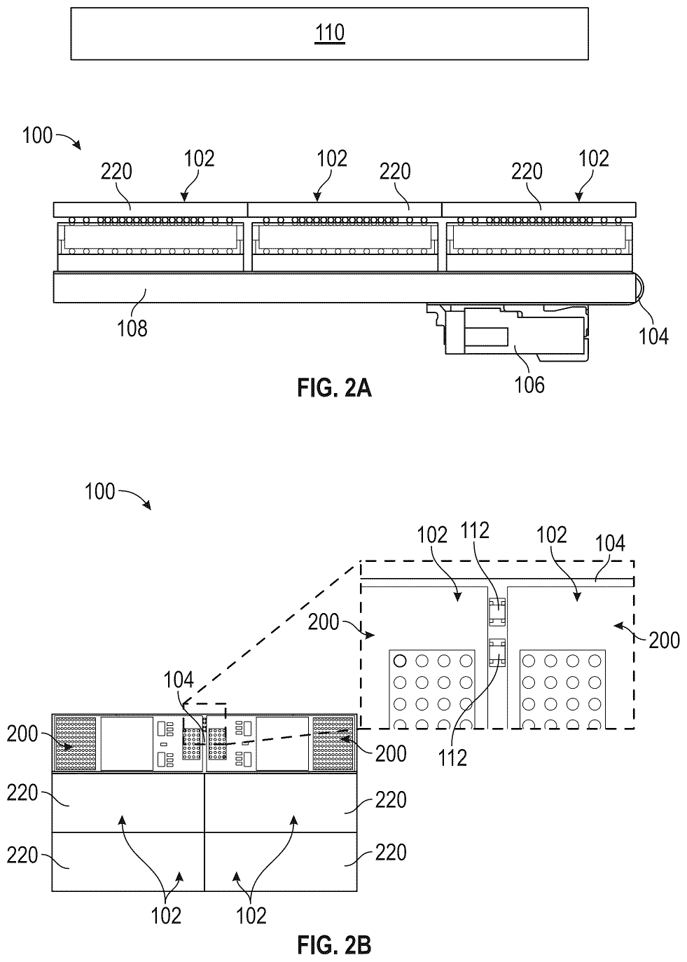

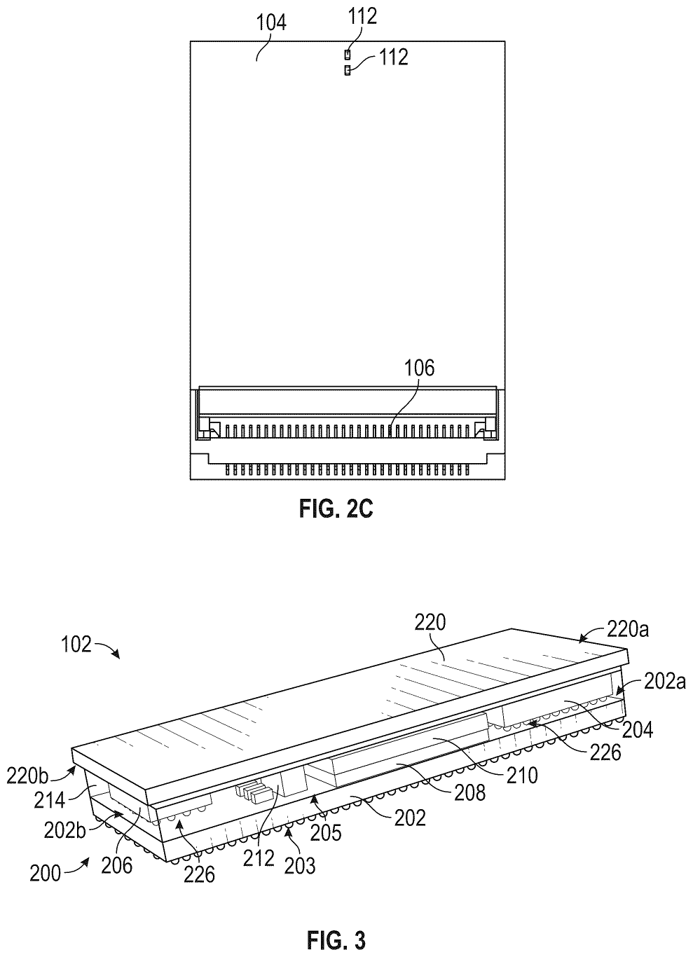

FIG. 1 illustrates a perspective view of an example sensor assembly 100 for processing light into electrical signals (e.g., capture light photons and convert them into digital data that can be processed and stored). FIGS. 2A and 2B illustrate a schematic side view and top view, respectively, of the sensor assembly 100. FIG. 2C illustrates a schematic top view of a flexible substrate 104. The sensor assembly 100 can include one or more sensor modules 102 (which may also be referred to herein as “chiplets”) arranged in various configurations to satisfy design constraints or system requirements. For example, as illustrated in FIG. 1, the sensor module 102 can be arranged in a 3×2 configuration comprising six sensor module 102 but could be arranged in a 2×2, 3×2, 4×2, 5×2, 6×2, 3×3, 3×4, 3×5, 3×6, etc. depending on design requirements and/or sizing constraints. As shown in FIG. 1, a single sensor module 102 can comprise ⅙^{th} of the sensor area of the sensor assembly 100, which can vary depending on the number of total sensor modules 102.

The sensor modules 102 can be mounted (e.g., locally reflowed with solder balls or otherwise electrically connected) onto a flexible substrate 104. The flexible substrate 104 can include a connector 106 disposed on an end of the flexible substrate 104. The connector 106 can electrically couple the sensor module 102 attached to the flexible substrate 104. The connector 106 may also be made of a flexible material, such as a pigtail connector, and can include embedded metallic traces and conductive contacts configured to electrically connect to the sensor module 102 described below. The flexible substrate 104 can be a flexible substrate with integrated bond pads, leads, and/or traces, which allows for a low profile. The flexible substrate 104 can include multiple conductive leads configured to electrically couple to external devices and/or substrates. In some implementations, the sensor module 102 can be mechanically and/or electrically coupled to the flexible substrate 104 by way of local reflow techniques. In other implementations, the sensor modules 102 can be soldered to the flexible substrate 104, while in yet other implementations, the sensor modules 102 can be coupled to the flexible substrate 104 using anisotropic conductive film (ACF) or non-conductive paste (NCP) technologies. As shown in FIGS. 2B and 2C, the flexible substrate 104 can include passive and/or non-passive devices 112, for example clock resistors, surface mounted onto the flexible substrate 104. Clock resistors, such as the 0201 clock resistor, can terminate a transmission line or clock signal. Additionally, clock resistors can also match the impedance of a transmission line to minimize signal reflections and improve signal integrity. The devices 112 can be positioned at or near the end of a transmission line or near a receiver in a circuit of the flexible substrate 104. For example, as shown in FIG. 2B, the devices 112 can be placed on the flexible substrate 104 (on a side furthest from the connector 106) and between the sensor modules 102.

Flexible substrates can be useful in arrangements where it is desirable for the substrate to conform to a particular geometry employed within a system. In some implementations, flexible substrates can be made of a flexible plastic material, such as polyimide or PEEK, and can include integrated bond pads, traces and leads similar to those used in conventional PCB substrates. The flexible substrate can refer to a material and/or base layer that can bend, fold, and/or conform to various shapes without losing its structural integrity. A flexible substrate can be used as the foundation for flexible PCBs in an electronic component. The flexibility of the substrate can allow the electronic components to be mounted on a surface that can bend and/or flex, enabling the creation of devices that can conform to non-planar surfaces or undergo deformation. The flexible substrate can have a Young's modulus (i.e., elastic modulus) that is less than other PCB materials such as FR-4 (i.e., more flexible). The Young's modulus is a material property that describes stiffness and is defined as the ratio of stress to strain within the elastic limit. The Young's modulus of a flexible substrate (e.g., printed circuit board (PCB)) can depend on the materials used in its construction. Flexible PCBs can be made with materials such as polyimide, which is known for its flexibility. The Young's Modulus of polyimide can be in the range of 2 to 4 GPa as compared to 35 to 40 GPa for FR-4 used in rigid PCBs. The flexible substrate 104 can further have a flexural modulus (i.e., a measure of a material's resistance to deformation under applied bending stress that characterizes a material's stiffness in flexural or bending loading conditions) that is less when compared to other PCB materials such as FR-4. When a material is subjected to a bending force, it undergoes deformation, and the flexural modulus quantifies how much the material will deform under this stress. For example, the flexural modulus of polyimide can be 2 to 4 GPa which is less than 14 to 20 GPa of FR-4. The flexible substrate 104 can be easily bent or folded to conform to a particular geometry, which permits contacting downstream components in a variety of configurations. Furthermore, traces and leads can be patterned on the flexible substrate in very small dimensions. For example, in some implementations, the traces can have line widths and spaces on the order of about 15 to 20 μm, and the leads or bond pads can have widths or diameters of about 200-300 μm with similar spacing, such that the pitch is on the order of 400-600 μm.

In some implementations, the flexible substrate 104 can be attached to a stiffener 108. The flexible substrate 104 can be mounted on and/or coupled to a portion of the stiffener 108. The stiffener 108 can provide structural support for the sensor assembly 100. As shown in FIGS. 1 and 2A, the flexible substrate 104 can be wrapped around an end and/or edge of the stiffener 108. The stiffener 108 can be made of any suitable low CTE material, such as Invar® sold by Aperam Imphy Alloys, which is part of a family of low expansion iron-nickel alloys. An Invar® stiffener is an alloy known for its low coefficient of thermal expansion (CTE). Its CTE is nearly zero over a wide range of temperatures, making it ideal for applications where dimensional stability under temperature variations is crucial. The stiffener 108, particularly an Invar® stiffener 108, can minimize the effects of thermal expansion and contraction, reducing the risk of warping, distortion, or misalignment due to temperature changes. An Invar® stiffener 108 can be comprises of an Invar® alloy, which is composed iron and nickel, with controlled levels of other elements to achieve its properties. The low thermal expansion characteristics of Invar® can make it valuable for applications where precise dimensional control is required, such as in the construction of optical systems, semiconductor manufacturing equipment, and aerospace structures subjected to wide temperature variations.

In some implementations, the sensor assembly 100 can be included in an imaging system such as a computed tomography (CT) device. CT devices are useful in a variety of fields, including medical imaging, industrial imaging, nondestructive testing, and subsurface imaging. In the imaging system, a source can emit radiation in the direction of an object to be imaged (e.g., a patient). For example, the source can emit x-ray radiation. There can be various conventional mechanisms to emit radiation for imaging purposes. After some portion of the radiation passes through an object, it reaches a one-dimensional (1D) or two-dimensional (2D) array of sensor assemblies 100 positioned opposite the source. The sensor assemblies 100 can be configured to convert detected radiation (e.g., visible light) to electrical signals using a photodiode array (PDA), which can be the sensor of this imaging example. In some implementations, the sensor assembly 100 can also be configured to convert detected x-ray radiation to visible light, or the system can include a separate device, such as scintillator 110, for that purpose. In other implementations, detected x-ray radiation may be converted to electrical signals in other ways. The sensor assembly 100 can also configured to convert the analog signals received from the PDA into digital signals that can be transmitted by a transmission elements to an external control module. The sensor assembly 100 can also perform various other preprocessing and/or preconditioning operations on the detected signals before transmission to the control module. After the processed digital signals are received by the control module, the control module can further process the digital signals into a readable output, such as an image on a display device or a report of various measured values calculated from the received signals. To obtain a full 3D image of the object, the system can rotate around the object to obtain images of a subject at various angles.

In other examples, the imaging system can be an ultrasound device. An ultrasound device can include a source of ultrasonic waves and a detector (or detector array) that includes one or more sensor modules similar to those described in more detail below. Furthermore, the sensor module(s) can be used in nuclear imaging implementations, such as PET scans and gamma ray imaging techniques. In yet other implementations, the sensor modules can be used in various non-imaging arrangements (e.g., electrical, electronic or optical applications that employ a compact module that includes both a sensor and a processor). For example, microelectromechanical systems (MEMS) devices, such as MEMS microphones and accelerometers, may include both a sensor die and a processor die near the sensor in order to process signals from the sensor. In these examples, sensor modules similar to those illustrated herein may be useful in providing a compact sensor package.

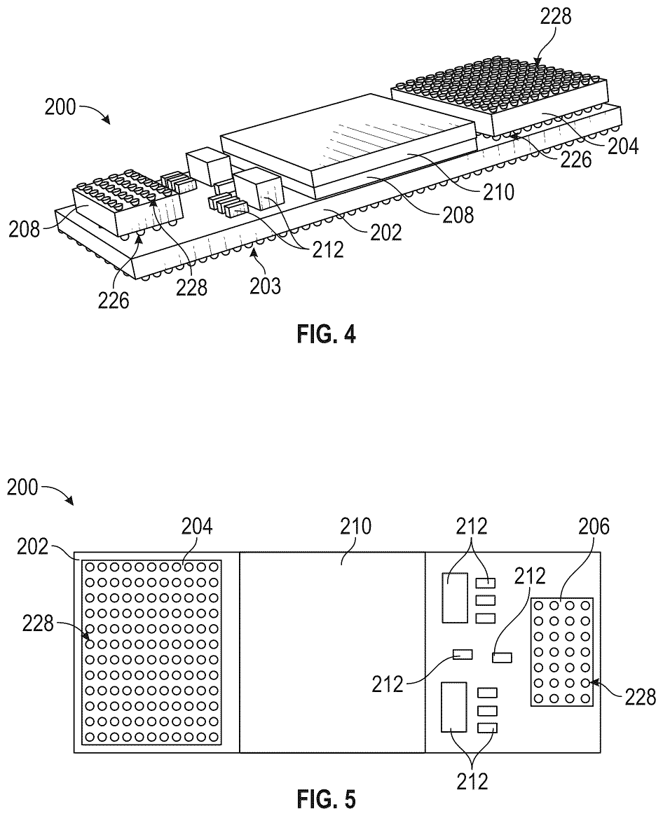

FIG. 3 illustrates a perspective view of an example sensor module 102. FIG. 4 illustrates a perspective view of a partially assembled sensor module 102. FIG. 5 illustrates a top perspective view of a partially assembled sensor module 102. The sensor module 102 can include a device package 200 and a sensor die 220 disposed (e.g., mounted, bonded, attached, etc.) over the device package 200. The device package 200 and the sensor die 220 can be in electrical and mechanical communications. As shown in FIG. 3, the device package 200 can include a vertical interconnect structure 204 (also mentioned herein as a “first vertical interconnect”). In some implementations, the device package 200 can include a second vertical interconnect structure 206. The first vertical interconnect structure 204 can be positioned at a first end of the device package 200 and the second vertical interconnect structure 206 can be positioned at a second end of the device package 200. In some implementations, the first vertical interconnect structure 204 and/or the second vertical interconnect structure 206 can comprise interconnecting laminates (i.e., interposer and/or an interconnect substrate) configured to facilitate the connection between different components within the sensor module 102 and the device package 200.

The device package 200 can further include a processor die 208. The processor die 208 can be positioned adjacent to the first vertical interconnect structure 204. In some implementations, the processor die 208 can be positioned between the first vertical interconnect structure 204 and the second vertical interconnect structure 206. The processor die 208 can comprise active processing circuitry configured to process electrical signals (e.g., analog signals). The processor die 208 can comprise a microcontrollers, digital signal processors, application specific integrated circuit (ASIC), a field programmable gate array (FPGA) or other programmable logic device, discrete gate or transistor logic, discrete hardware components, or any combination thereof. In some implementations, the processor die 208 can comprises an analog-to-digital converter configured to receive an analog input signal, which could be voltage, current, and/or another continuous-time signal and represent anything from temperature, pressure, light intensity, to sound waves. The analog input signal can then be sampled at discrete intervals and the processor die 208 captures the value of the analog signal at each sampling instant. At each sampling instant, the sampled analog value is then converted into a digital value and then output by the processor die 208 to be further processed, stored, and/or transmitted by digital systems.

The processor die 208 can be electrically connected to the first vertical interconnect structure 204 via electrical traces (not shown). The first vertical interconnect structure 204 can further provide electrical communication between the processor die 208 and the sensor die 220. In some implementations, the second vertical interconnect structure 206 can also include electrical traces connecting the processor die 208 and sensor die 220. The conductive traces within the first vertical interconnect structure 204 and/or the second vertical interconnect structure 206 can route signals between different components, allowing for data transfer, power distribution, and communication within the device package 200. Additionally, the first vertical interconnect structure 204 and second vertical interconnect structure 206 can provide mechanical support and structural integrity to the device package 200. During operation of the sensor module 102, the first vertical interconnect structure 204 can communicates signals from the sensor die 220 to the corresponding processor die 208 (i.e., each processor die 208 of a device package 200 is paired with a corresponding sensor die 220 to form the sensor modules 102). The processor die 208 can electrically communicate with a large number of pixels (e.g., 128 pixels) of the corresponding sensor die 220, which can advantageously increase the resolution of the imaging device. In some implementations, for example as shown in FIG. 1, each of the six illustrated sensor dies 220 of the sensor modules 102 can include 128 pixels electrically coupled to the processor die 208 of the device packages 200, for a total of 786 pixels in the 6-sensor array. In other implementations, each sensor die can include a fewer or a greater number of pixels, including e.g., 512 pixels per sensor module 102. Additionally, the first vertical interconnect structure 204 and the second vertical interconnect structure 206 can include electrical terminals 228 on a top (i.e., upper) surface for mounting to other components (e.g., sensor die 220). In some implementations, the electrical terminals 228 are ground down to form conductive pads to connect the sensor die 220.

The device package 200 can also include a substrate 202. The substrate 202 can comprise a substrate having a nonconductive or insulating base substrate with conductive routing traces (not shown) (e.g., at least partially embedded traces), such as a laminate substrate, a printed circuit board (PCB) substrate, a semiconductor interposer, a flexible substrate comprising a polymer with embedded traces, or any other suitable substrate. The conductive routing traces can laterally and vertically transfer signals through the substrate 202 in various implementations. The first vertical interconnect structure 204, second vertical interconnect structure 206, and/or processor die 208 can be disposed (e.g., mounted, bonded, attached, etc.) to the substrate 202. In some implementations, the first vertical interconnect structure 204 can be mounted on a first end 202a of the substrate 202 and the second vertical interconnect structure 206 mounted to a second end 202b opposite the first end 202a of the substrate 202. The first vertical interconnect structure 204 and the second vertical interconnect structure 206 can be mounted to the substrate 202 by electrical terminals 226 (e.g., a ball grid array) as shown in FIG. 4 or other conductive adhesives. In some implementations, the first vertical interconnect structure 204 and/or the second vertical interconnect structure 206 can be configured to connect the substrate 202 of the device package 200 to the sensor die 220. The substrate 202 can also include conductive traces disposed on and/or within the substrate 202 such that signals can be transferred between the first vertical interconnect structure 204 to the processor die 208. A lower or bottom surface of the substrate 202 can include a conductive adhesive 203 (e.g., a plurality of solder balls) for mounting the device package 200 to the flexible substrate 104 and/or other components.

In some implementations, as shown in FIG. 3, the device package 200 can include a redistribution layer 205 along a lower side of an encapsulant compound 214 rather than the substrate 202. The redistribution layer 205 can be deposited on a lower surface of the device package 200. The redistribution layer 205 include a dielectric layer deposited on the device package 200 to form an insulating barrier. The dielectric layer is then selectively etched to create trenches or vias corresponding to the photoresist pattern. A thin seed layer of metal, typically copper, is deposited over the entire surface using sputtering or electroplating methods, providing a base for further metal deposition. The RDL conductive metal (e.g., copper) can be electroplated onto the seed layer within the patterned areas to achieve the required thickness. Planarization processes, such as chemical mechanical polishing (CMP), can be utilized to ensure a smooth and even surface. The residual photoresist can be removed, leaving behind patterned metal traces and vias. Additional dielectric layers can be deposited and patterned for multiple RDLs, with the photolithography, etching, and metal deposition steps repeated for each layer. The process concludes with the application of a passivation layer to protect the metal traces from environmental factors, and openings are created in the passivation layer to facilitate connections to subsequent packaging levels.

The device package 200 can further include a radiation shield 210 disposed (e.g., mounted, bonded, attached, etc.) over the processor die 208. In some implementations, the radiation shield 210 attached to the processor die 208 by an adhesive. The radiation shield 210 can be sized and comprise a material selected to as to effectively prevent damaging radiation (for example, X-rays) from impinging on active circuitry of the processor die 208. In some implementations, the radiation shield 210 can be wider than the processor die 208, e.g., a lateral footprint of the radiation shield 210 can be wider than a corresponding lateral footprint of the processor die 208, such that the processor die 208 lies within the shadow of the radiation shield 210 relative to an illumination source. In some implementations, as shown in FIG. 5 illustrating a top perspective view of the device package 200 of the sensor module 102, the width of the processor die 208 may be the same as or larger than the width of the radiation shield 210. In such implementations, the active circuitry in the processor die 208 may be disposed within the shadow of the radiation shield 210 such that, even though portions of the processor die 208 may lie outside the footprint of the radiation shield 210, the sensitive or active circuitry is disposed inside the lateral footprint of the radiation shield 210.

The radiation shield 210 can comprise any suitable type of shield that can effectively block or sufficiently limit damaging radiation (e.g., X-rays) from impinging on active circuitry of the processor die 208. The radiation shield 210 can comprise a material and shape configured to block at least 75%, at least 85%, at least 90%, or at least 95% of X-ray radiation impinging on the device package 200. The radiation shield 210 can comprise a material and shape configured to block 75% to 100% or 90% to 100% of the X-ray radiation impinging on the device package 200. For example, the radiation shield 210 can comprise a metal having a density greater than 9 g/cm3, greater than 10 g/cm3, or greater than 15 g/cm3. In some implementations, the shield can comprise a metal having a density in a range of 9 g/cm3 to 22 g/cm3. In various implementation, the radiation shield 210 can comprise tungsten, lead, or molybdenum. A thickness of the radiation shield 210 can be suitably selected based on the material composition of the radiation shield 210. For example, a shield that has a higher percentage of a high density metal (e.g., tungsten) than another shield may be made thinner than the other shield formed of a lower percentage of the high density metal. In various implementations, the thickness of the radiation shield 210 can be at least 0.4 mm, or at least 0.5 mm, to provide adequate shielding for the processor die 208. For example, the thickness of the shield 8 can be in a range of 0.4 mm to 3 mm, in a range of 0.4 mm to 2 mm, in a range of 0.4 mm to 1.2 mm, in a range of 0.4 mm to 1 mm, in a range of 0.45 mm to 1 mm, in a range of 0.5 mm to 1 mm, in a range of 0.45 mm to 0.8 mm, in a range of 0.5 mm to 0.8 mm, in a range of 0.45 mm to 0.65 mm, or in a range of 0.7 mm to 0.9 mm.

Referring again to FIG. 3, the device package 200 can further include passive components 212 mounted to the substrate 202. The passive components 212 can comprise capacitors, inductors, resistors, etc. mounted to the substrate 202 with respective adhesives adjacent to the processor die 208. The passive components 212 may not be shielded, for example, in arrangements in which the passive components 212 may not be sensitive to the impinging electromagnetic radiation. The device package 200 can also include an encapsulant compound 214 (e.g., a molding compound) which can be molded over at least the first vertical interconnect structure 204, second vertical interconnect structure 206, processor die 208, radiation shield 210, and/or passive components 212 to encapsulate these components of the device package 200. In some implementations, any one of the first vertical interconnect structure 204, second vertical interconnect structure 206, processor die 208, radiation shield 210, and/or passive components 212 can be completely embedded in the encapsulant compound 214. The encapsulant compound 214 can protect the electrical components mounted to the substrate 202 from environmental factors such as moisture, mechanical stress, and contaminants. In some implementations, the encapsulant compound 214 comprises an organic mold compound. In some implementations, the encapsulant compound 214 is ground down to expose the contact pads formed from electrical terminals 228 of the first vertical interconnect structure 204 and/or second vertical interconnect structure 206. FIG. 4 illustrates the device package 200 without the encapsulant compound 214 and the sensor die 220.

As mentioned above, the sensor module 102 can include the sensor die 220 having a first surface 220a and a second surface 220b opposite the first surface 220a. The second surface 220b of the sensor die 220 can be mounted to a front side of the device package 200. In some implementations, the first surfaces 220a of the sensor dies 220, as illustrated in FIG. 1, can be co-planar with one another. The sensor die 220 can comprise a photodiode array (PDA) having a plurality of photosensitive elements that convert electromagnetic radiation to an electrical current. Although not shown, radiation modifiers, such as filters or scintillators, can be provided over the front side of the sensor die 220. The sensor module 102 can accordingly transduce light impinging on the PDA into electrical signals which can be conveyed to conductive traces in the first vertical interconnect structure 204 to the substrate 202 and then to the processor die 208.

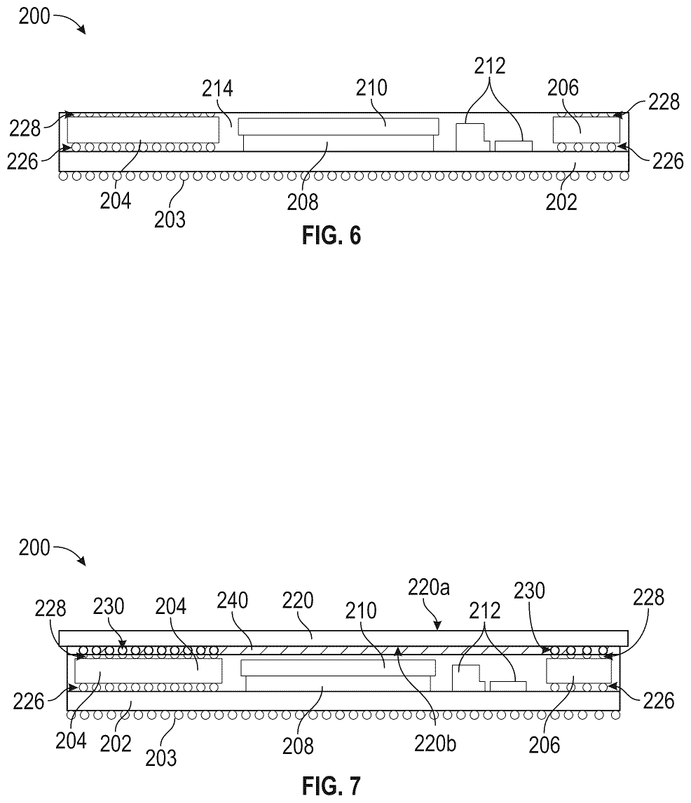

In some implementations, the sensor die 220 can be electrically connected to the device package 200 by way of a conductive adhesive, such as solder bumps, anisotropic conductive film (ACF), a conductive epoxy, etc. For example, the electrical terminals 228 disposed on the top surface of the first vertical interconnect structure 204 and the second vertical interconnect structure 206 can be ground down as shown in FIG. 6. Next, as illustrated in FIG. 7, additional electrical terminals 230 (e.g., solder balls) can be disposed along the ground electrical terminals 228 for mounting the sensor die 220 to the first vertical interconnect structure 204 and the second vertical interconnect structure 206 of the device package 200. The sensor die 220 can then be reflowed to the device package 200 and an underfill 240 can be disposed between the device package 200 and the sensor die 220. The underfill 240 can reinforce the mechanical connection between the device package 200 and sensor die 220. The underfill 240 can fill any gaps located between the device package 200 and the sensor die 220, and, once cured or solidified, the underfill 240 can forms a strong, elastic bond that helps to distribute mechanical stresses, improve thermal cycling reliability, and prevent fatigue and cracking along the connection between the device package 200 and the sensor die 220.

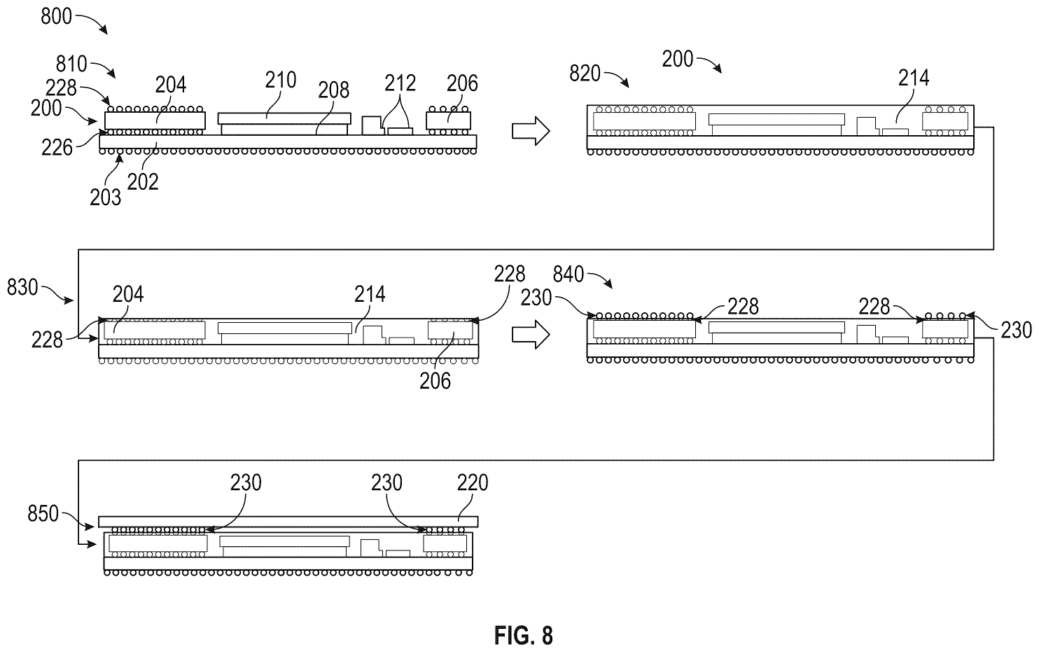

FIG. 8 is a graphical flow diagram illustrating an example process 800 for assembling a sensor module 102. At step 810, the device package 200 can be formed. Components listed above (e.g., conductive adhesive 203, first vertical interconnect structure 204, second vertical interconnect structure 206, processor die 208, radiation shield 210, passive components 212, electrical terminals 226, and/or electrical terminals 228) can be mounted to a substrate 202. Mounting the components can comprise using reflow techniques to attach the first vertical interconnect structure 204, second vertical interconnect structure 206, processor die 208, and/or passive components 212 to the substrate 202. The radiation shield 210 can be attached to the processor die 208 by an adhesive such as epoxy. The components mentioned herein can be electrically connected to each other by conductive traces of the substrate 202.

At step 820, the device package 200 can be overmolded by the encapsulant compound 214. In some implementations, the encapsulant compound 214 comprises an organic compound, or alternatively, an inorganic compound.

At step 830, the encapsulant compound 214 of the device package 200 can be ground down to expose electrical terminals 228 disposed on a top surface of the first vertical interconnect structure 204 and the second vertical interconnect structure 206. The electrical terminals 228 can also be ground down during step 830. In some implementations, the ground-down electrical terminals 228 can be ground down such that, for example, approximately the widest part of the electrical terminals 228 is exposed through the encapsulant compound 214. In some implementations, the electrical terminals 228 can be ground down such that the remaining portion of the electrical terminals 228 is between approximately 1% to 99% of the original height of the electrical terminals 228.

At step 840, additional electrical terminals 230 (e.g., solder balls or other conductive adhesives) are disposed onto the exposed electrical terminals 228. In some implementations, the additional electrical terminals 230 and form a ball grid array (BGA).

At step 850, a sensor die 220 can be mounted to the additional electrical terminals 230 such that the sensor die 220 is mechanically and electronically connected to the device package 200. In some implementations, the mounting technique of step 850 can comprise a reflow technique. In some implementations, a underfill can be disposed between the device package 200 and the sensor die 220.

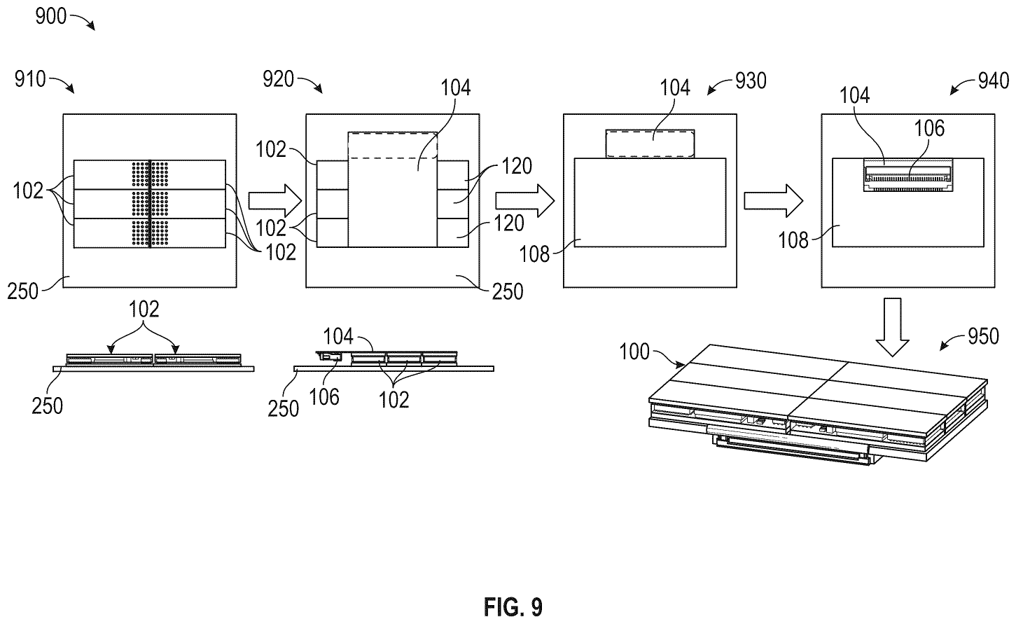

FIG. 9 is a graphical flow diagram illustrating an example process 900 for assembling a sensor assembly 100. At step 910, a sensor module 102 are disposed on a glass carrier 250. In some implementations, as shown in FIG. 9, six sensor modules 102 can be arranged on the glass carrier 250.

At step 920, a surface of the flexible substrate 104 is mounted to the bottom surface of the substrate 202 of the sensor module 102 by way of the conductive adhesive 203 to provide electrical communication between contact pads (not shown) of the flexible substrate 104 and the sensor module 102. The mounting of the flexible substrate 104 to the substrate 202 can comprise a reflow technique.

At step 930, a first surface of the stiffener 108 can be attached to a partial assembly comprising of the sensor module 102 and flexible substrate 104. In some implementations, the stiffener 108 is attached to the flexible substrate 104 by an adhesive (e.g., epoxy).

At step 940, a free portion of the flexible substrate 104 and the connector 106 are wrapped an edge of the stiffener 108 and adhered to a second surface opposite the first surface of the stiffener 108. The free portion and the connector 106 can be attached to the second surface by an adhesive (e.g., epoxy).

At step 950, the assembled sensor assembly 100 can be released from the glass carrier and cleared to remove any particles and/or debris accumulated during the process 900.

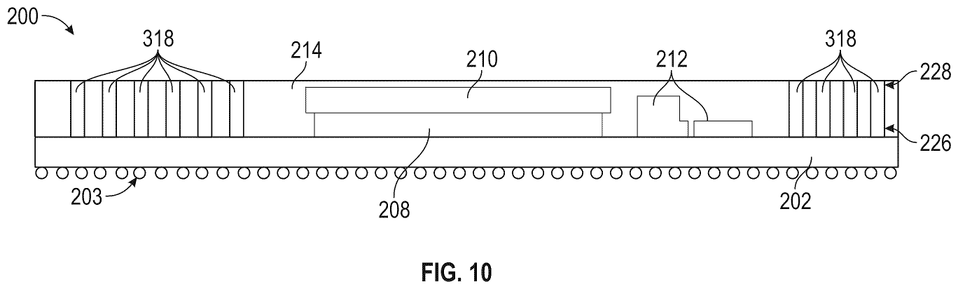

FIG. 10 illustrate a schematic side view of another implementations of a the device package 200. Unless otherwise noted, components of FIG. 10 can be the same as or generally similar to like-numbered components of FIGS. 2A-7. For example, device package 200 can include substrate 202, conductive adhesive 203, processor die 208, radiation shield 210, passive components 212, encapsulant compound 214, electrical terminals 226, and/or electrical terminals 228. However, as shown in FIG. 10, the device package 200 can include through-mold-vias 318 rather than the first vertical interconnect structure 204 and/or the second vertical interconnect structure 206. In some implementations, the through-mold-vias 318 can comprise copper pillars extending through the encapsulant compound 214. The through-mold-vias 318 can possess a lower resistance value than the first vertical interconnect structure 204 and/or second vertical interconnect structure 206 which can improve electrical performance and lead to higher signal integrity. Additionally, the through-mold-vias 318 can enable finer pitch connections allowing for higher density interconnections and thus reducing footprint. The through-mold-vias 318 can be ground down for connecting to electrical terminals 230 of the sensor die 220. In some implementations, the through-mold-vias 318 can be connected to the substrate 202 by the electrical terminals 226 (e.g., a ball grid array) or other conductive adhesives. Additionally, the through-mold-vias 318 can include electrical terminals 228 on a top (i.e., upper) surface for mounting to other components (e.g., sensor die 220). In some implementations, the electrical terminals 228 are ground down to form conductive pads to connect the sensor die 220.

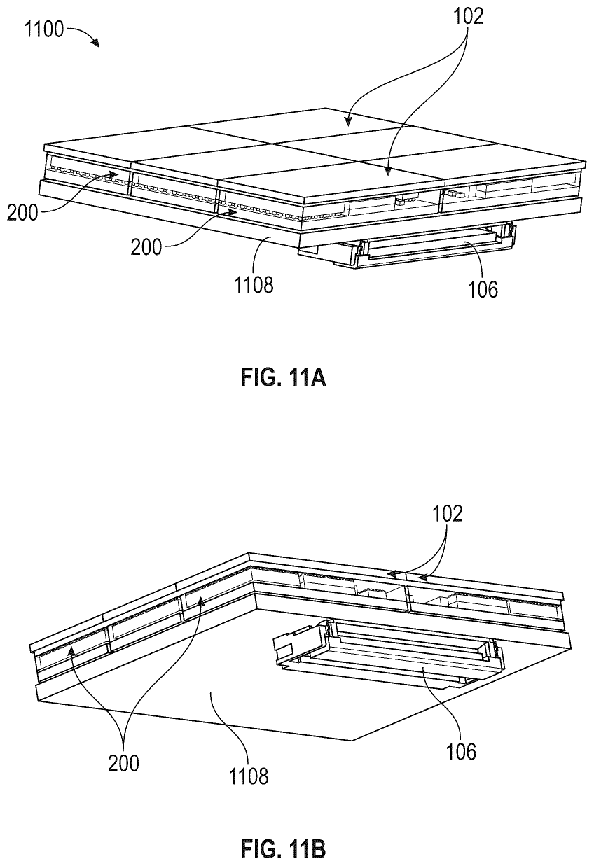

FIGS. 11A and 11B illustrate a schematic perspective views of another exemplary assembly 1100. Unless otherwise noted, components of FIGS. 11A and 11B can be the same as or generally similar to like-numbered components of FIGS. 1-2C. For example, the assembly 1100 can include sensor modules 102 and connector 106. However, as shown in FIGS. 11A and 11B, the exemplary assembly 1100 can include an assembly substrate 1108 rather than the flexible substrate 104 wrapped around and attached to the stiffener 108. The sensor modules 102 can be disposed on and in electrical communication with the assembly substrate 1108 instead of the flexible substrate 104. The connector 106 can be disposed on an end of the assembly substrate 1108. The connector 106 can electrically couple the sensor module 102 via the assembly substrate 1108. The assembly substrate 1108 can be comprised of a single layer or multiple layers. Additionally, the assembly substrate 1108 can be comprised of ceramic, glass, and/or a laminate material. By attaching the sensor modules 102 to the assembly substrate 1108, a signal(s) (e.g., analog signal(s)) from the sensor modules 102 can travel through the assembly substrate 1108 via one or more through substrate vias (TSVs) to the connector 106 rather than the signal(s) from each sensor modules 102 traveling along the flexible substrate 104 to the connector 106 as shown in FIG. 1-2C.

In the foregoing specification, the systems and processes have been described with reference to specific implementations thereof. It will, however, be evident that various modifications and changes may be made thereto without departing from the broader spirit and scope of the implementations disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and implementations of the implementations may be made and still fall within the scope of the disclosure. It should be understood that various features and implementations of the disclosed implementations can be combined with, or substituted for, one another in order to form varying modes of the implementations of the disclosed systems and processes. Any methods disclosed herein need not be performed in the order recited. Thus, it is intended that the scope of the systems and processes herein disclosed should not be limited by the particular implementations described above.

It will be appreciated that the systems and methods of the disclosure each have several innovative implementations, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single implementations. Conversely, various features that are described in the context of a single embodiment also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain implementations include, while other implementations do not include, certain features, elements and/or states. Thus, such conditional language is not generally intended to imply that features, elements and/or states are in any way required for one or more implementations.

While certain implementations have been described, these implementations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative implementations may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various implementations described above can be combined to provide further implementations. The accompanying claims and their equivalents are intended to cover such forms or modifications as would fall within the scope and spirit of the disclosure.

Several illustrative examples of sensor modules and related systems and methods have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps may be arranged or performed differently than described and components, elements, features, acts, or steps may be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations may also be implemented in combination in a single implementation. Conversely, various features that are described in the context of a single implementation also may be implemented in multiple implementations separately or in any suitable subcombination. Moreover, although features may be described above as acting in certain combinations, one or more features from a claimed combination may in some cases be excised from the combination, and the combination may be claimed as a subcombination or variation of a subcombination.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures may or may not be drawn and/or shown to scale, but such scale should not be limiting, since dimensions and proportions other than what are shown are contemplated and are within the scope of the disclosed implementations. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various examples may be used in all other examples set forth herein. Additionally, any methods described herein may be practiced using any device suitable for performing the recited steps.

For purposes of summarizing the disclosure, certain aspects, advantages and features of the implementations have been described herein. Not all, or any such advantages are necessarily achieved in accordance with any particular example of the implementations disclosed herein. No aspects of this disclosure are essential or indispensable. In many examples, the devices, systems, and methods may be configured differently than illustrated in the figures. or description herein. For example, various functionalities provided by the illustrated modules may be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification may be included in any example.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded a fair constructions consistent with this disclosure, the principles and the novel features disclosed herein.

1. A sensor assembly for an imaging system, the sensor assembly comprising:
a sensor module, the sensor module comprising:
a device package comprising:
a first vertical interconnect structure;
a processor die electrically connected to the first vertical interconnect structure via conductive traces;
a radiation shield mounted to the processor die; and
an encapsulant in which the first vertical interconnect structure, the processor die, and the radiation shield are at least partially embedded within; and
a sensor die disposed over the device package and in electrical communication with the processor die, wherein during operation of the sensor module, the first vertical interconnect structure communicates signals from the sensor die to the processor die;
wherein the radiation shield is positioned between the processor die and the sensor die.

2. The sensor assembly of claim 1, further comprising a second vertical interconnect structure, wherein the first vertical interconnect structure is positioned at a first end of the device package and the second vertical interconnect structure is positioned at a second end of the device package, and wherein the second vertical interconnect structure is at least partially embedded in the encapsulant.

3. The sensor assembly of claim 1, wherein the radiation shield is mounted to the processor die by an adhesive.

4. The sensor assembly of claim 1, wherein the device package further comprises at least one of active circuitry or passive circuitry.

5. The sensor assembly of claim 1, wherein the first vertical interconnect structure and the processor die are mounted to a substrate and the conductive traces are embedded in or on the substrate.

6. The sensor assembly of claim 1, further comprising a redistribution layer disposed on a lower surface of the first vertical interconnect structure and the processor die, wherein the redistribution layer comprises the conductive traces.

7. The sensor assembly of claim 1, further comprising:
a flexible substrate, wherein a plurality of sensor modules are mounted to the flexible substrate, and
a stiffener, wherein the flexible substrate is attached to and folded around an edge of the stiffener.

8. The sensor assembly of claim 7, wherein the flexible substrate includes a connector assembly.

9. The sensor assembly of claim 1, further comprising an assembly substrate, wherein a plurality of sensor modules are mounted to the assembly substrate, and wherein the assembly substrate includes a connector assembly.

10. The sensor assembly of claim 1, wherein the first vertical interconnect structure comprises a laminate substrate.

11. The sensor assembly of claim 1, wherein the first vertical interconnect structure comprises copper pillars encapsulated in a molding compound.

12. A sensor assembly for an imaging system, the sensor assembly comprising:
a sensor module, the sensor module comprising:
a device package comprising:
a first vertical interconnect structure;
a processor die electrically connected to the first vertical interconnect structure via conductive traces; and
an encapsulant in which the first vertical interconnect structure and the processor die are at least partially embedded in the encapsulant; and
a sensor die disposed over the device package and in electrical communication with the processor die, wherein during operation of the sensor module, the first vertical interconnect structure communicates signals from the sensor die to the processor die.

13. The sensor assembly of claim 12, further comprising a radiation shield mounted to the processor die by an adhesive, the radiation shield is positioned between the processor die and the sensor die, wherein the radiation shield is at least partially embedded in the encapsulant.

14. The sensor assembly of claim 12, further comprising a second vertical interconnect structure, wherein the first vertical interconnect structure is positioned at a first end of the device package and the second vertical interconnect structure is positioned at a second end of the device package, and wherein the second vertical interconnect structure is at least partially embedded in the encapsulant.

15. The sensor assembly of claim 12, wherein the device package further comprises at least one of active circuitry or passive circuitry.

16. The sensor assembly of claim 12, wherein the first vertical interconnect structure and the processor die are mounted to a substrate and the conductive traces are embedded in or on the substrate.

17. The sensor assembly of claim 12, further comprising a redistribution layer disposed on a lower surface of the first vertical interconnect structure and the processor die, wherein the redistribution layer comprises the conductive traces.

18. The sensor assembly of claim 12, further comprising:
a flexible substrate, wherein a plurality of sensor modules are mounted to the flexible substrate, and
a stiffener, wherein the flexible substrate is attached to and folded around an edge of the stiffener.

19. The sensor assembly of claim 18, wherein the flexible substrate includes a connector assembly.

20. The sensor assembly of claim 12, further comprising an assembly substrate, wherein a plurality of sensor modules are mounted to the assembly substrate, and wherein the assembly substrate includes a connector assembly.

21.-61. (canceled)
